(19) United States
(12) Patent Application Publication
(10) Pub. No.: US 2013/0268302 A1
(43) Pub. Date: Oct. 10, 2013

(54) SYSTEM AND METHOD FOR FACILITATING A SOCIAL TRIP PLANNING EXPERIENCE

(71) Applicant: Ranjith Jayaram, San Jose, CA (US)

(72) Inventor: Ranjith Jayaram, San Jose, CA (US)

(73) Assignee: Google Inc., Mountain View, CA (US)

(21) Appl. No.: 13/439,797

(22) Filed: Apr. 4, 2012

(51) Int. Cl. G06Q 10/02

(52) U.S. Cl. 705/5

(57) ABSTRACT

A system and machine-implemented method for facilitating a social travel planning environment, including receiving an indication of interest in an trip element being viewed at a remote store by a user participating in a social trip planning session, wherein the remote store is one of an online store or an offline store, wherein the social trip planning session includes one or more participants interested in planning a trip, retrieving, using the one or more computing devices, information regarding the trip element in response to receiving the indication, the information including trip element information corresponding to the trip element and providing the trip element and the retrieved information to be displayed to the one or more participants of the social trip planning session and providing a mechanism for receiving feedback regarding the trip element from the one or more participants.

### BACKGROUND

The subject disclosure generally relates to online travel planning applications, and, in particular, to facilitating social travel planning.

People usually travel in groups with family or friends. The process of planning a trip includes deciding on a mutually agreeable date and destination and planning the appropriate transportation, accommodations and activities for the trip. Travelers use various online travel sites for planning their transportation (e.g., transportation to and from the destination, and during the destination), accommodations and activities for the trip. Most of these online travel sites require that a single user plan the various elements of the trip for the group or that each user plan their own part of the trip separately knowing the agreed upon elements.

As online social networking and interactions with contacts become more popular, it may be desirable to mirror a real world trip planning experience.

### SUMMARY

The disclosed subject matter relates to a method, executed on one or more computing devices, for facilitating a social travel planning environment, the method comprising receiving an indication of interest in an trip element being viewed at a remote store by a user participating in a social trip planning session, wherein the remote store is one of an online store or an offline store, wherein the social trip planning session includes one or more participants interested in planning a trip. The method further comprising retrieving, using the one or more computing devices, information regarding the trip element in response to receiving the indication, the information including trip element information corresponding to the trip element and providing the trip element and the retrieved information to be displayed to the one or more participants of the social trip planning session and providing a mechanism for receiving feedback regarding the trip element from the one or more participants.

The disclosed subject matter also relates to a system for facilitating a social trip planning session environment, the system comprising one or more processors and a machine-readable medium comprising instructions stored therein, which when executed by the processors, cause the processors to perform operations comprising receiving an indication of interest in an trip element being viewed at a remote store by a user participating in one or more social trip planning sessions, wherein the remote store is one of an online store or a offline store, wherein each of the one or more social trip planning sessions includes one or more participants associated with the social trip planning session, and wherein each of the one or more social trip planning session is associated with context information. The operations further comprising retrieving information regarding the trip element in response to receiving the indication, the information including at least one of trip element information corresponding to the trip element or retailer information corresponding to the store. The operations further comprising identifying one of the one or more social trip planning sessions based on the context information associated with each of the one or more social trip planning sessions and adding the trip element and the retrieved information to the identified social trip planning session, and providing a mechanism for receiving feedback regarding the trip element from the one or more participants.

The disclosed subject matter also relates to a machine-readable medium comprising instructions stored therein, which when executed by a machine, cause the machine to perform operations comprising receiving an indication of interest in an trip element being viewed at a remote store by a user participating in a social trip planning session, wherein the social trip planning session includes one or more participants, and wherein the social trip planning session is associated with context information including one or more of trip element characteristics desirable by the one or more participants, and context details regarding the details of the trip, the context detail including one or more of date, date range, time, transportation type, activity type, preferred provider, one or more trip companions, or price range. The operations further comprising retrieving information regarding the trip element in response to receiving the indication, the information including trip element information corresponding to the trip element and adding the trip element and the retrieved information to the social trip planning session, such that the trip element is displayed to each of the one or more participants, and providing a mechanism for receiving feedback regarding the trip element from the one or more participants.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example client-server network environment which provides for facilitating social trip planning sessions.

FIG. 2 illustrates a flow chart of an example process for creating a social trip planning session.

FIG. 3 illustrates a flow chart of an example process for adding participants to a social trip planning session.

FIG. 4 illustrates a flow chart of an example process for adding a trip element to the social trip planning session.

FIG. 5 illustrates a flow chart of an example process for collaborating on context details regarding a trip.

FIG. 6 illustrates an example screen shot of a graphical user interface displaying a web browser including a social travel planning application.

FIG. 7 illustrates a screen shot of a graphical user interface displaying an example social shopping cart.

FIG. 8 conceptually illustrates an electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

I. Overview

The subject disclosure provides a system and method for facilitating social travel planning for one or more users connected online (e.g., social networking contacts). A social trip planning session may be initiated by a user. Upon initiating the social trip planning session, the user may invite one or more other users (e.g., others traveling with the user) to participate in the social trip planning session. The social travel planning application facilitates collaboration and feedback between the social trip planning session participants and unifies the planning of all elements of a trip into a single session while allowing users to plan different elements of the trip at different websites or through other means (e.g. actual physical travel store, books, travel agents, phone etc.).

A user may log into the social travel planning application and begin a social trip planning session. Once the user begins the social trip planning session, the user may enter information regarding the actual context of the trip including various trip objectives and preferences such as dates, destination, types of destination, types of activities, travel companion characteristics, accommodation characteristics and preferences, transportation characteristics and preferences. The user may designate one or more contacts or groups (e.g., social groups) to be invited to the social trip planning session. Alternatively, the user may ask that the invitation to join the social trip planning session be shared with all contacts of the user (e.g., at one or more social networking sites). Still further, the system may use such information to recommend one or more contacts that are likely to be good companions for the user's desired trip or have expertise or knowledge regarding the desired trip (e.g., based on various information regarding the contacts such as past social travel experiences, profile information). The user may select one or more of the recommended contacts for joining the social trip planning session. The selected contacts are notified about the ongoing social trip planning session and provided with the context of the social trip planning session.

The invited contacts may receive an invitation and may join the social trip planning session. Participants may include those interested in joining the actual trip and/or those with expertise or knowledge about trip planning who may not necessarily participate in the actual trip once it is planned. Upon joining the social trip planning session, the participants may enter additional trip objectives and preferences. The additional objectives and preferences may be added to the trip context information provided by the user initiating the meeting. In one instance, before adding the additional trip objectives and/or preferences to the trip context information, the additional trip objectives and/or preferences may be displayed to the user initiating the social trip planning session and the user may decide whether the additional trip objectives and/or preferences should be added to the trip context information. Alternatively, the additional trip objectives and/or preferences may be displayed to all participants or those participants participating in the actual trip and put to vote. If enough people approve the objectives, then those objectives may be added to the context information. Trip context information including objectives and/or preferences may be modified at any time during the social trip planning session by one or more of the participants of the social trip planning session. Only certain participants (e.g., the session initiator and/or those authorized or approved by the session initiator) may have authority to modify the trip context information.

Once the social trip planning session participants are ready to begin the social trip planning session, the participants may individually browse various travel websites (e.g., similar to a solitary online trip planning experience), or physical stores (e.g., offline store, travel agent, books, phone) for various trip elements that the participants may be interested in purchasing. The online travel planning sites and physical stores may be independent from the social travel planning application, and are not required to vary any infrastructure to allow for social trip planning sessions according to the embodiments of the present subject matter.

Trip elements may include transportation to the trip destination, between one or more trip destinations and/or at the destinations, accommodation(s), activities, packages, restaurants and other facilities. Once the system detects an indication of interest of a participant in a certain trip element (e.g., transportation, accommodation, activity), information regarding the trip element may be retrieved. The information associated with the trip element may include one or more of cost, time/date, trip element type, trip element source (e.g., online retailer site, offline store, travel agent, books, etc.), trip element provider (e.g., aircraft carrier, hotel chain, activity or tour provider) and other similar information. The trip element and information associated with the trip element are posted to the social trip planning session for review and comment by participants of the social trip planning session.

The social travel planning application may be implemented as a browser extension or a separate browser-based or software-based application. Upon receiving an indication of a user being at an online travel site, the social travel planning application may determine a trip element being viewed by the user (e.g., using the URL) and post the trip element being viewed to the social travel planning application. Similarly, a participant at a physical store may scan a barcode or identifier and/or enter information regarding the item (e.g., take a picture, write a description) and may select to share the item with other participants of the social trip planning session. Once the system detects an indication of interest of a participant in a certain item, the item is then posted to the social shopping application for review and comment by all other participants in the social shopping trip. In another example, online retailer sites may integrate social shopping trip capability into their website. For example, an online store may provide a button to launch the social shopping application and/or a button to post the item currently being viewed to the social shopping trip.

The system may also, with proper permissions, provide information as to the location of the participants (e.g., the online store or physical store that the user is currently at) and/or participants may explicitly share information about the online website or physical store they are currently shopping at, to prompt other participants to visit the same stores (e.g., online site or physical store), thus making the trip planning experience less solitary.

Participants can vote and comment on trip elements posted to the social trip planning session. The social trip planning session display includes mechanisms for receiving feedback regarding the posted trip elements from the participants of the social trip planning session. The participants can for example like or dislike a trip element posted by other participants, vote “yes” or “no” on the trip element or recommend other trip elements in lieu of the posted trip elements. In one example, the system may further provide mechanisms such that users can provide reasons for their feedback (e.g., endorsement, opinions and rating) regarding a trip element. For example, the system, upon receiving a certain endorsement, rating or other opinion regarding the trip element, may provide a list of reasons to the user and the user may select a reason for providing the feedback. The reasons provided for selection to the user may be customized to the feedback provided by the user. For example, a specific type of rating, vote or opinion, may trigger a listing of reasons specific to the feedback provided by the user. Additionally, the system may provide the user with a comment box where the user may provide feedback, an explanation about their feedback or comments regarding the trip element.

In addition to providing mechanism for feedback, the social travel planning application may further provide chat capability such that the participants of the social trip planning session may discuss various items or other information relating to the shopping trip using the chat capability. In one example, in addition the chat capability may be used for topics unrelated to the social trip planning session.

The system may receive the feedback from each of the one or more participants and updated the social trip planning session to display the feedback associated with each trip element to the one or more participants. Thus, the participants are able to view the trip elements posted to the social trip planning session and all feedback provided by the participants and associated with the posted trip elements. Based on the comments, feedback or votes by various participants of the social trip planning session a trip element from the social trip planning session may be selected and added to the social shopping cart for purchase. The trip elements detected or posted to the social trip planning session may be limited to trip elements relating to the trip context information.

The participants can view the information regarding the trip element and may vote on whether the trip element is approved for the trip, and may further provide feedback and ratings regarding the trip element. Once a trip element has been approved by enough participants (e.g., according to votes, average rating score, text comments or other feedback recognized by the system and/or participants as approval), the trip element may be selected (e.g., either automatically, or by a participant) and added to the social shopping cart for the trip. A pre-defined approval threshold may be set by the system and/or one or more participants of the social trip planning session and the trip element may be added to the social shopping cart upon receiving an indication that the threshold has been met. Participants of the social shopping cart may add one or more trip elements posted to the social trip planning session to various social shopping carts associated with the participants (e.g., a communal social shopping cart, personal social shopping cart and/or group social shopping cart) at any time during the social trip planning session.

A communal social shopping cart may be associated with the social trip planning session and may include trip elements placed into the social shopping cart by various participants of the social trip planning session. In one example, where users add trip elements to the communal shopping cart, the trip element may be added in a quantity that meets the demands of all participants of the social trip planning session or those participants participating in the actual trip. A communal social shopping cart may alternatively be associated with a group of users (e.g., a family, work group). The social shopping cart for the group may include trip elements placed by the users within the group from various social trip planning sessions that the group is participating in and that the group wishes to purchase. Furthermore, the group's communal shopping cart may include other trip elements the group members wish to add to the shopping cart independent of the social trip planning session. Each participant of the social trip planning session may be associated with a personal social shopping cart and the trip element may be added to the personal social shopping cart for each of the participants of the social trip planning session, or for those who have indicated an interested in joining the trip element (e.g., those that voted yes for the trip element).

When an trip element is added to the one or more social shopping carts associated with the social trip planning session and/or participants of the social trip planning session, information regarding the trip element and/or feedback regarding the trip element may be retrieved from one or more locations associated with the trip element (e.g., source locations such as the online retailer, offline store or social trip planning session associated with the trip element) and added to the social shopping cart. For example, feedback provided by participants of the social trip planning session may be added to the social shopping cart. Thus, the social shopping cart provides an augmented virtual shopping cart having information regarding the trip element and feedback data from participants of the social trip planning session where the trip element has been posted. The social trip planning session may be ongoing even after the trip element is added to the social shopping cart. The system may automatically update the information and feedback corresponding to the trip element as the information and/or feedback associated with the trip element within the social shopping cart is modified (e.g., as the trip element information is modified with the social trip planning session or when additional feedback is provided by members of the social trip planning session). The system may continue to update the trip element information and/or feedback within the social shopping cart until the trip element is selected for purchase.

The social shopping cart may also be used by the user when the user is shopping online outside the context of a social trip planning session. The social shopping cart provides the user with an augmented social shopping cart including all trip elements from offline or online stores and having feedback and/or trip element information regarding the trip elements which may be updated when the feedback and/or trip element information is added or modified at the source locations maintaining or displaying the trip element.

The social shopping cart associated with the social trip planning session and/or one or more participants of the social trip planning session may be shared and/or viewed by other users. For example, the participants of a social trip planning session may be able to view one another's social shopping cart, and may select trip elements from a contact's social shopping cart and place the trip element within their own shopping cart or post the trip elements to a social trip planning session they are currently participating in. In one example, each contact of the user having access to the shopping cart may have a different view of the shopping cart. For example, the trip elements displayed to participants in a social trip planning session may be limited to those added from the same social trip planning session and the other trip elements may not be displayed to. The user may adjust the access or viewing rights to his/her social shopping cart (e.g., communal or individual social shopping cart) such that different contacts have different access rights with respect to the social shopping cart of the user (e.g., different rights as to which trip elements they may see, whether they can add trip elements from the social shopping cart to their shopping cart, whether they can add to the social shopping cart or modify the social shopping cart).

Participants of the social trip planning session may further collaborate on trip context details including trip objectives and preferences such as trip dates, trip destination, activity types, trip companions, and other similar trip context details. For example, a suggested date range, trip destination, trip destination type, activity type, activity and/or other trip context detail may be posted to the social trip planning session and participants may provide feedback and/or vote on the trip context details similar to trip elements. The agreed upon trip context details may be then used to purchase one or more trip elements, and may further be added to the trip context information. For example, the context details may be used to filter the trip elements posted to the social trip planning session such that only trip elements meeting the agreed upon context details are displayed within the social trip planning session user interface.

The system may further provide recommendations for trip context details such as dates, destinations, activities and trip elements such as flights, hotels, activities to the participants of the social trip planning session, and the participants can collaborate on the recommendations provided by the system in addition to trip elements or context details posted by participants.

The system may provide one or more recommendations to participants of the social trip planning session during the social trip planning session. The recommendations may include recommendations for one or more trip elements relevant to the social trip planning session, one or more trip element sources (e.g., offline stores or online retailer sites) that the participants may be interested in visiting, one or more trip context details, other active (e.g., ongoing) social trip planning sessions that the participants may be interested in viewing and/or joining, one or more social shopping carts that may include trip elements of interest to the participants of the social trip planning session and/or one or more users (e.g., contacts of the one or more participants of the social trip planning session) that may be interested in joining the social trip planning session.

Recommendations may be presented to the user based on the activity of the participants of the social trip planning session. For example, the system may determine one or more trip element characteristics relevant to the social trip planning session and may provide recommendations for trip elements having the specific trip element characteristics. The trip element characteristics are determined based upon one or more of context information provided by participants of the social trip planning session (e.g., the user creating the social trip planning session), trip elements added to the social trip planning session, feedback provided by the participants of the social trip planning session, and trip elements added and/or to a social shopping cart associated with the social trip planning session and/or one or more participants of the social trip planning session. The trip element characteristics may include price range, destination, activity types, number of trip participants, trip element sources or stores (e.g., specific carriers or hotel chains and/or specific travel sites or travel agencies), trip date/time, or other similar trip element characteristics determined to be preferred and/or desirable according to the activity of the participants of the social trip planning session.

The system may further take into account preferences, purchasing and/or travel history associated with each of the participants of the social trip planning session or those participants participating in the actual trip when making recommendations. The social travel planning application may maintain a user profile associated with each user. Each user may be a participant in one or more social trip planning sessions. The system may determine user preferences based on the user's activity in past or ongoing social trip planning sessions. Such preferences may include trip element characteristics such as price range, destination, activity types, trip companions, trip element sources or stores (e.g., specific carriers or hotel chains and/or specific travel sites or travel agencies), trip date/time, or other similar trip element characteristics determined to be preferred and/or desirable according to the activity of the user within one or more social trip planning sessions, purchasing and/or travel history.

The activities of the participants within past or concurrent social trip planning sessions, purchasing history and/or travel history of the participants may be used for making recommendations regarding trip elements and/or context details for the trip. For example, the participant information may be used to determine destinations that the participant has already traveled to. The system may then present destination recommendations to the participants based on the travel history of the participants (e.g., destinations similar to those the participants typically travel to, the same destination when the destination appears as a favored destination, or different destinations where it appears that participants do not desire to visit recently visited destinations). With respect to date and time recommendations, the participants of the social trip planning session may grant access to their personal calendar to the social travel planning application and the system may provide recommendations on dates and times that would work for all participants by referencing the schedule for each participant of the trip (with proper permissions). The date and time recommendations may also be made based on information gathered for each participant according to the participants activities within past or concurrent social trip planning sessions, purchasing history and/or travel history (e.g., if the user is already participating in a social trip planning session with a set date, the system may recommend alternate dates).

In addition, the system may determine one or more contact preferences for each user (e.g., contacts the user usually enjoys planning with or relies on when making purchasing decisions). The preferences of participants of the social trip planning session may be used when making recommendations for participants to invite to the social trip planning session.

The system may also identify information regarding similar social trip planning sessions or users (e.g., based on the trip element characteristics associated with the social trip planning session and or participants) and may provide recommendations based on such information. For example, where a similar trip was planned by one or more users, the system may provide recommendations for accommodations, activities and other trip elements or context details based on the trip elements and context details of the similar trips. Similarly, preferences, purchasing history and/or travel history of one or more users determined to be similar to the participants of the social trip planning session and/or participants in the actual trip may be used when making recommendations for trip elements and/or context information.

The system may also make price-based recommendations based on trip elements and feedback data within the social trip planning session. In one example, the price-based recommendations may include identifying trip elements within the social trip planning session and identifying the same or similar trip elements offered for sale at a lower price. In one example, the system may identify the trip element and may perform a search for equivalent trip elements (e.g., trip elements having similar trip element characteristics) offered at a lower price, or otherwise more favorable to the user (e.g., preferred brand, preferred store, preferred size) and may provide the trip element as a recommendation within the social trip planning session. Price-based recommendations may further include group offers. Since the social trip planning session includes a group of users desiring to shop for similar trip elements (e.g., based on the context information), the system may search for one or more group offers based on the number of participants and may provide the group offers as a recommendation within the social trip planning session.

The recommendations may be displayed to the user within the user interface displaying the social trip planning session trip elements and feedback. One or more of the recommendations may further be annotated with social information. For example, with respect to trip element or store recommendations, the system may provide feedback information available (e.g., from other social trip planning sessions). In one example, the system may provide an overall feedback or rating regarding an trip element based on the popularity of the trip element (e.g., how many others have liked, purchased or provided comments regarding the trip element), the relevance of the trip element (e.g., how closely it meets the preferences indicated within the social trip planning session), and other indications that the trip element is desirable to the participants of the social trip planning session.

Additionally, the system may provide one or more advertisements to the participants of the social trip planning session based on same or similar information described above for making recommendations of trip elements to the user. Advertisers may create ad campaigns and provide targeting information including various trip context details, travel planning attributes including for example trip element characteristics, number of participants (either in the social trip planning session or the actual trip), user preferences, and various other attributes associated with a social trip planning session. The system upon determining that a social trip planning session is in progress may determine one or more of trip element characteristics relevant to the social trip planning session, preferences, purchasing and/or travel history associated with participants of the social trip planning session and/or information regarding similar social trip planning sessions or users (e.g., based on the trip element characteristics associated with the social trip planning session and or participants). Based on the information the system may determine one or more advertisements based on targeting criteria associated with the advertisements that are optimal for presentation to participants of the social trip planning session.

Similarly, the system may use the information described above including trip element characteristics relevant to the social trip planning session, preferences, purchasing and/or travel history associated with participants of the social trip planning session and/or information regarding similar social trip planning sessions or users (e.g., based on the trip element characteristics associated with the social trip planning session and or participants), to provide users of the social travel planning application with search results based upon their participation in one or more social trip planning sessions. For example, the system may, upon receiving a user search request for content, find search results that meet the search criteria provided by the user and are relevant to the information gathered regarding one or more social trip planning sessions that the user is participating in, or has participated in previously.

The social travel planning application may also build a single itinerary for the trip based on trip elements selected and placed within the social shopping cart of the trip, where the itinerary includes the information and feedback for each trip element. The itinerary may be displayed to all participants of the social trip planning session and/or participants in the actual trip. The itinerary and/or portions of the itinerary may further be shared with other users (e.g., contacts of participants of the social trip planning session or other users with proper permissions). For example, a user may, upon completing the planning of the trip, share the entire trip planning sessions and/or itinerary with one or more other users (e.g., other users not necessarily participating within the social trip planning session).

The social travel planning application unifies the trip planning experience of all participants and for all activities by providing a mechanism for collaborating and planning all elements of the trip including context details and/or trip elements within a single social trip planning session while maintaining the flexibility of online trip planning at various online retailer (e.g., travel websites) or offline resources (e.g., travel agents, books, over the phone). As the social travel planning application maintains the associations between users, social trip planning sessions, trips, context details, trip elements, and information and feedback regarding each trip element, the social travel planning application provides a social trip planning session that may be viewed across multiple browser sessions. That is, users of the social travel planning application may log out and in of the application and view all social trip planning sessions in progress that they are participating in. The system provides for seamless participation in social trip planning sessions across multiple devices, since the social travel planning application may be implemented as a web-based or soft-ware based application and/or as a mobile application. Furthermore, the social travel planning application may be used across various online and offline retailers without limitation, because the application does not require that the website or offline retailer infrastructure be changed to support the social travel planning application.

The term “trip element,” as used herein, encompasses its plain and ordinary meaning including, but not limited to, various products or services related to travel or purchased for use during or in association with a trip, offered for sale at one or more online sites and/or offline (i.e., non-internet based) stores. Each “trip element” may be identifiable by a name, and/or a trip element identifier (e.g., trip element identification number or barcode), and may be associated with “trip element information” such as name, price, availability, source (i.e. the retailer offering the trip element for sale or the entity offering the trip service or product), characteristics (e.g., date, time, carrier), description (e.g., description of features), or other similar information.

The term “online retailer site” as used herein encompasses its plain and ordinary meaning including but not limited to a webpage, website, web application or other software-based application, tool or entity accessible to a user over the internet and offering one or more trip elements available for sale. The term may encompass both retailers directly selling the trip element, or tools, websites or entities providing a link to one or more retailers providing the trip element for sale. The terms “online retailer site”, “retailer site” or “online store” may be used interchangeably throughout the description of the subject matter and encompass same or similar meanings. The term “offline store” or “physical store” as used herein encompasses its plain and ordinary meaning, including, but not limited to, a brick and mortar store, travel agency, phone service, or other offline entity or establishment accessible to the user offline (i.e., other than through the internet) and offering one or more trip elements for sale. The terms “retailer” and “store” may be generally used throughout the embodiment and generally refers to “online retailer sites” or “offline stores” providing a trip element offered for sale.

Users of social networking services may create associations with one another. The phrase “social networking service” as used herein encompasses its plain and ordinary meaning, including, but not limited to, an online service, platform or site that focuses on building and reflecting of social associations and interactions among users. These associations may be stored within a social graph at each social networking service. Such user associations may be defined on a user-to-user basis, or as a group of users associated through membership within a group. As used herein, “contacts” refer to other users that a user is associated with, at one or more social networking services.

A user may create “social groups” (e.g., social circles) including one or more contacts to organize his/her associations. The social groups may be additionally used to control distribution of messages and content to contacts of the user. For example, “social circles” are categories to which a user can assign their social networking contacts and better control the distribution and visibility of social networking messages as well as other multimedia content (e.g., documents, and other collaboration objects). In accordance with the subject disclosure, a social circle is provided as a data set defining a collection of contacts that are associated with one another. As used herein, a social circle can be described from the perspective of an individual that is the center of a particular collection of socially interconnected people, or from the aggregate perspective of a collection of socially interconnected people. In some examples, a social circle can have narrowly defined boundaries, all of the members of the social circle may be familiar with one another, and permission may be required for a member to join a social circle. In accordance with the subject disclosure, a user of an electronic device may define a social circle, and the social circle, as a data set defining a collection of contacts, may reflect a real-life social circle of the user.

For example, a user of an electronic device may have different groups of friends, coworkers, and family, and there may be some overlap among those groups (e.g., a coworker who is also considered to be a friend, a family member who is also a coworker). Through the creation and use of social groups (e.g., social circles), the user can organize and categorize his/her contacts into various different groupings.

II. Example Client-Server Network Environment for Facilitating a Social Travel Planning Experience

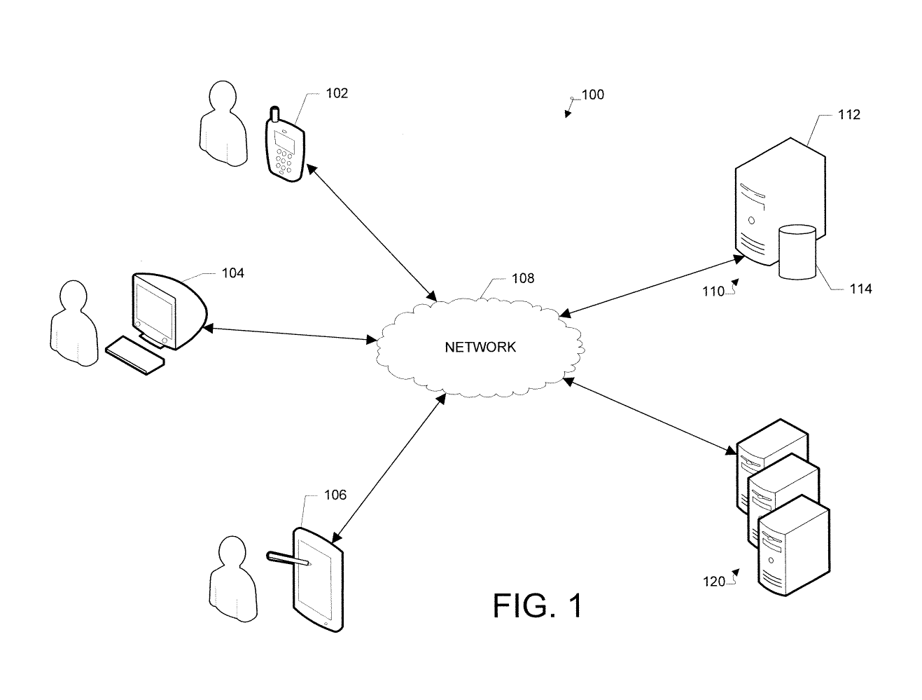

FIG. 1 illustrates an example client-server network environment which provides for facilitating social trip planning sessions. A network environment 100 includes a number of electronic devices 102, 104 and 106 communicably connected to a server 110 and/or remote servers 120 by a network 108. Server 110 includes a processing device 112 and a data store 114. Processing device 112 executes computer instructions stored in data store 114, for example, for facilitating a social trip planning session application for use at electronic devices 102, 104 and 106.

In some example embodiments, electronic devices 102, 104 and 106 can be computing devices such as laptop or desktop computers, smartphones, PDAs, portable media players, tablet computers, televisions or other displays with one or more processors coupled thereto or embedded therein, or other appropriate computing devices that can be used to for displaying a web page or web application. In the example of FIG. 1, electronic device 102 is depicted as a smartphone, electronic device 104 is depicted as a desktop computer, and electronic device 106 is depicted as a PDA.

A user interacting with a client device (e.g., electronic devices 102, 104 and 106) may access a social travel planning client application and provide login information (e.g., using a user name and password). The client application may be a stand alone browser-based or other software-based application at the user's computer, or may be embedded as a feature within one or more software or browser-based applications running on the client device, within a browser (e.g., a social networking service or an online retailer site) or as a browser extension or may be implemented as a mobile application.

The login information may be received at a server hosting the social travel planning application (e.g., hosted at server 110), and the user may be authenticated. The server hosting the social travel planning application may maintain one or more social trip planning sessions, and one or more user accounts for users of the social travel planning application (e.g., participants participating in such social trip planning sessions). The social trip planning session may be associated with context information, list of participants, identity of trip creator, etc. The server (e.g., server 110), may further maintain an association between social trip planning sessions and one or more trip elements and context details posted to each of the social trip planning sessions. The trip elements may further be associated with trip element information, retailer information and feedback data received from one or more participants of the social trip. Context details may be associated with context detail information, feedback data, and other similar information. Additionally, the social trip planning session may maintain one or more social shopping carts associated with each user of the social travel planning application or a communal social shopping cart associated with a social trip planning sessions or groups of users. The information may be stored at one or more databases communicably coupled to the server (e.g., server 110).

The system may retrieve information regarding the user, including one or more social trip planning sessions that the user is participating in and may provide a data set including information regarding each social trip planning session (e.g., context details, trip elements, trip element information and/or feedback data) to the client device of the user. The client device may generate a travel planning application user interface displaying one or more social trip planning sessions that the user is participating in. The social travel planning application user interface may be displayed as a window at a side of the user interface displaying a third party retailer site the user is currently viewing, or may be embedded within one or more third party retail sites accessible through the browser. Additionally, the social travel planning application may be implemented as a mobile application at the user's mobile device. The social travel planning application may also be a stand-alone software-based application running on the client device.

Once within the social travel planning application, the user may create one or more social trip planning sessions and invite one or more contacts to participate in those social trip planning sessions. In one example, the user may create a social trip planning session and enter information regarding the social trip planning session (e.g., at the social travel planning application user interface). The information entered by the user is received at the social travel planning application (e.g., hosted at server 110) and used to create an instance of a social trip planning session associated with the user account of the user. The user may further select one or more contacts (e.g., contacts or social groups associated with the user at a social networking site) and may invite those contacts to join the social trip planning session. The system receives the list of contacts and may issue invitations to the one or more selected contacts, for example, including a link to the social trip planning session, and may send the invitation to the selected contacts (e.g., through email or messages sent to the social networking user accounts of the contacts). The contacts may select the link to join the social trip planning session. Once an indication of a contact joining the social trip planning session is received by the social travel planning system, the system associates the contact with the social trip planning session and provides a data set including information (e.g. context information, trip elements, trip element information, feedback) regarding the social trip planning session for display to the contact (at the contact's client device).

The participants of a social trip planning session may browse online retail sites and physical (offline) stores and may add one or more trip elements to the social trip planning session. The social travel planning application may be implemented as a browser extension. The online location of the user (e.g., a third party retailer website), and the trip element being viewed by the user at the online location may be detected using the URL, and the user may be provided with an opportunity to post the trip element within the social trip planning session. For example, upon receiving a request from the user to post the trip element to the social trip planning session (or automatically detecting user interest in a trip element while the user is logged into the social travel planning application), the browser may detect the URL and notify the browser extension. The browser extension may send the URL to a trip element search service (e.g., hosted at a remote server 120). The trip element search service may search across one or more databases for information regarding the trip element, and generate a trip element snippet. The snippet may include trip element information such as trip element name, photo, price, description, and other similar trip element information. The snippet is sent back to the browser extension, for displaying the trip element as part of the social travel planning application user interface.

Alternatively, some third party retailers may have an embedded button at their website which may launch the social travel planning application and/or allow the user to add trip elements to a social trip planning session by selecting the embedded button. Once a trip element is selected (e.g., using the embedded button), the system may retrieve trip element information regarding the trip element (e.g., from the specific online site that the user is shopping from). The system may generates a snippet and provide the snippet for display within the social travel planning application.

Similarly, trip elements from an offline store may be selected and shared with the participants of the social trip planning session at the social travel planning application. For example, a user at an offline store may take a picture of a trip element, enter the identifier of a trip element or information regarding the trip element or scan a barcode of the trip element and request that the trip element be posted to the social travel planning application. The system may retrieve trip element information regarding the trip element (e.g., through the trip element search service using the barcode). Additionally, the system, may then detect the location of the participant (e.g., through GPS or by querying the user) to detect store information. The trip element along with the information regarding the trip element may be posted to the social trip planning session. The trip elements detected or posted to the social trip planning session may be limited to trip elements relating to the context information associated with the social trip planning session.

Similarly, participants may post context details to the social trip planning session. Participants of the social trip planning session may collaborate on trip context details such as trip dates, trip destination, activity types and other similar trip context details. For example, a recommendation for a specific date range, trip destination, activities and other trip context details may be posted to the social trip planning session by a first user. The context detail is displayed to all participants of the social trip planning session and participants may provide feedback and/or vote on the trip context details similar to trip elements. The agreed upon trip context details may be used to purchase one or more trip elements and/or added to the trip context information. For example, the context details may be used to filter the trip elements posted to the social trip planning session such that only trip elements meeting the agreed upon context details are displayed within the social trip planning session user interface.

According to some aspects, remote servers 120 can be any system or device having a processor, a memory and communications capability for hosting various online retailer sites, remote social networking services, and/or a trip element search service. In one embodiment, remote servers 120 may be further capable of maintaining social graphs of users and their contacts. The remote social networking services hosted on the remote servers 120 may enable users to create a profile and associate themselves with other users at a remote social networking site. The remote servers 120 may further facilitate the generation and maintenance of a social graph including the user created associations. The social graphs may include, for example, a list of all users of the remote social networking site and their associations with other users of a remote social networking site. Remote servers 120 may further host a trip element search service coupled to one or more databases (hosted by remote servers 120) maintaining information regarding trip elements available online at one or more online retailer sites or at an offline store.

In some example aspects, server 110 and/or one or more remote servers 120 can be a single computing device such as a computer server. In other embodiments, server 110 and/or one or more remote servers 120 can represent more than one computing device working together to perform the actions of a server computer (e.g., cloud computing). In some embodiments, server 110 and/or one or more remote servers 120 may be coupled with various remote databases or storage services. Communications between the client devices 102-106, server 110 and/or one or more remote servers 120 may be facilitated through the HTTP communication protocol. Other communication protocols may also be facilitated including for example, XMPP communication, for some or all communications between the client devices 102-106, server 110 and one or more remote servers 120.

The network 108 can include, for example, any one or more of a personal area network (PAN), a local area network (LAN), a campus area network (CAN), a metropolitan area network (MAN), a wide area network (WAN), a broadband network (BBN), the Internet, and the like. Further, the network 108 can include, but is not limited to, any one or more of the following network topologies, including a bus network, a star network, a ring network, a mesh network, a star-bus network, tree or hierarchical network, and the like.

III. Processes for Facilitating a Social Travel Planning Experience

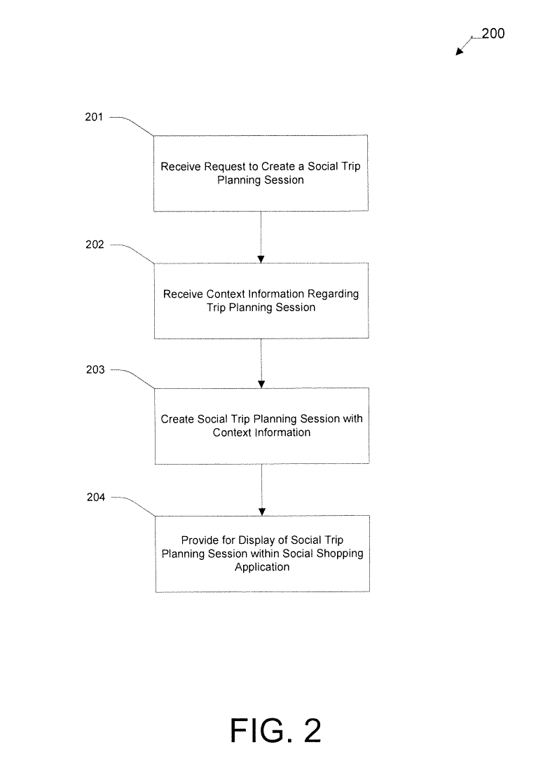

FIG. 2 illustrates a flow chart of an example process 200 for creating a social trip planning session. In block 201, the system receives a request to create a social trip planning session. A user may log into a social travel planning application and initiate a social trip planning session. Once the user requests to add the social trip planning session, the user may input information regarding the context of the social trip planning session (e.g., the trip elements and/or types of trip elements that the user wishes to shop for). The context information may include a set of keywords associated with the social trip planning session (e.g., destinations, date, trip elements and/or characteristics of trip elements that the user wishes to shop for and/or other trip planning objectives and/or preferences). In one example, the user may input the set of keywords and/or may input free-form natural language text describing what he/she wishes to do during the trip planning session. The system may receive the free-form input and extract relevant intelligence and/or information (e.g., one or more keywords). The extracted information may be associated with the social trip planning session as context information. In one example, each social trip planning session is limited to trip elements relating to the context information specified by the user. The user may create a social trip planning session and enter information regarding the social trip planning session at the social travel planning application user interface.

In block 202, the system receives the context information regarding the social trip planning session. In one example, the context information may define one or more context details and/or trip element characteristics associated with the social trip planning session. Additionally, the system may recommend additional context details or trip element characteristics to the user for selection and inclusion as part of the context information. For example, as described above, the system may make recommendations regarding context details based on information regarding the participants, information regarding similar social trip planning sessions and/or information regarding one or more similar users. The system may recommend one or more destinations, accommodations, transportation means, accommodation/transportation providers or brands, suggested date range(s) and time(s), or other context details and characteristics based on information regarding the user, one or more other participants or invited contacts, one or more other social trip planning sessions or other users similar to the social trip planning session participants.

In one example, the user or other participants of the social trip planning session (with proper permission or approval from the user) may modify the context information (e.g., to add or remove one or more one or more keywords indicating context details and/or trip element characteristics).

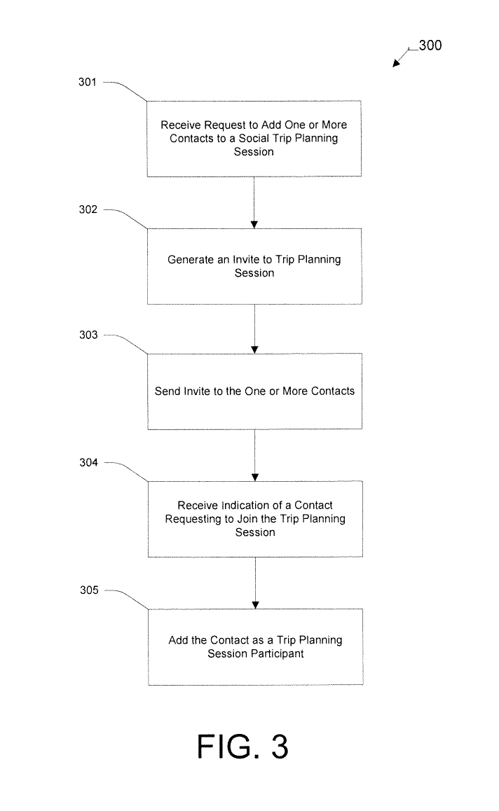

In block 203, the system creates a social trip planning session and associates the received context information with the social trip planning session. The information entered by the user and received in block 202 may be received at the system (e.g., hosted at server 110) and used to create an instance of a social trip planning session associated with the user account of the user. Furthermore, the user is added as the first participant of the social trip planning session. The system may further receive a request to invite one or more contacts or groups (e.g., social groups) to the social trip planning session. Alternatively, the user may ask that the invitation to shop be shared with all contacts of the user (e.g., at one or more social networking sites). In one example, the system may also recommend one or more contacts for the specific social trip planning session (e.g., based on various information regarding the contacts such as past social trip planning session experiences and/or profile information indicating contact shopping interests or expertise). An example process for adding participants to the social trip planning session is described in further detail below with respect to FIG. 3.

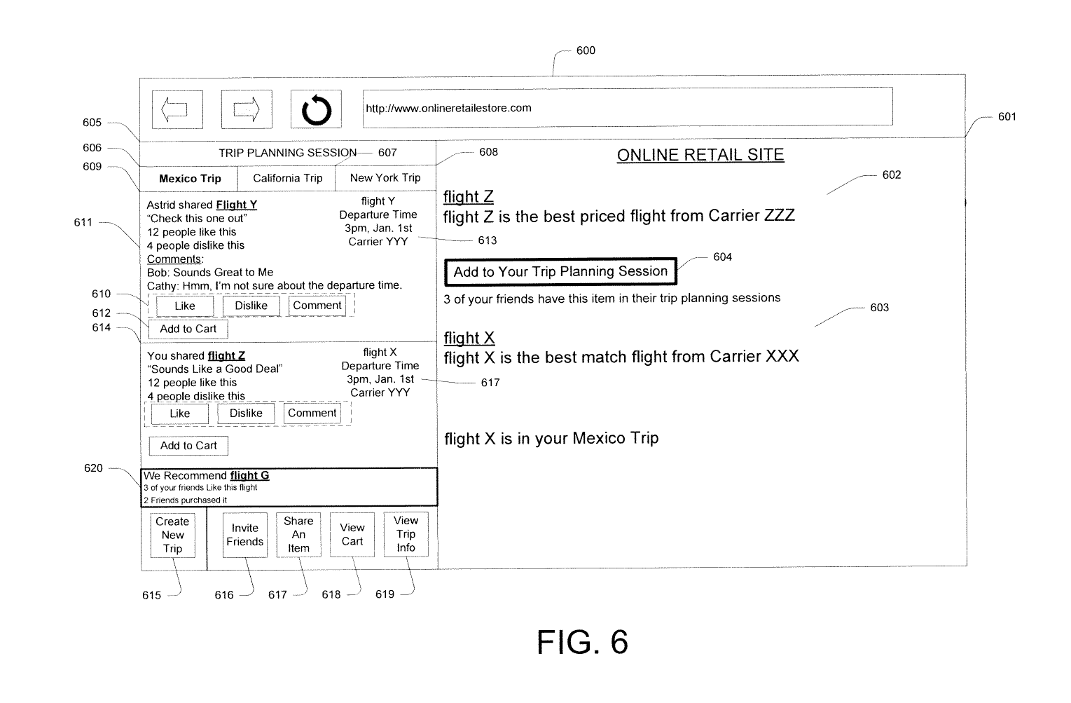

In block 204, the social trip planning session is provided for display within a user interface displaying the social travel planning application associated with the user's user account. In one example, the user may be associated with more than one social trip planning session and the social trip planning sessions may be displayed as tabs, lists or otherwise displayed to the user within the social travel planning application user interface. Additionally, the system may create a social shopping cart associated with the social trip planning session. An example graphical user interface displaying a social shopping trip is discussed in further detail below with respect to FIG. 6.

FIG. 3 illustrates a flow chart of an example process 300 for adding participants to a social trip planning session. In block 301, the system receives a request to invite one or more contacts to a social trip planning session. The contacts may include contacts or social groups associated with the user at a social networking service or contacts the user is otherwise associated with (e.g., over e-mail communication, or through real world contacts). The user may enter contact information for each user and/or may provide contact information for each contact.

The system may also recommend one or more contacts to the user and the user may select the recommended contacts and request that those contacts be invited to join the social trip planning session. The system may determine one or more item characteristics associated with the social trip planning session (e.g., according to the context information, trip elements and feedback within the social trip planning session), preferences, travel and purchase history of the participants of the social trip planning session and information regarding one or more similar social trip planning sessions or similar users and may recommend contacts to the user For example, the system may recommend contacts based on their preferences and expertise regarding the social trip planning session. Additionally, the system may determine contacts that the user prefers to travel with (e.g., based on previous social trip planning sessions) or those that the user relies on when making purchasing decisions and may recommend those contacts to the user for inviting to the social trip planning session. Furthermore, based on participants within similar social trip planning sessions, the system may suggest one or more of those participants as potential participants for the social trip planning session.

In block 302, the system generates an invite to the social trip planning session. The invite may include a link to the social trip planning session, and may further include information regarding the social trip planning session (e.g., the context of the social trip planning session), to allow the contacts to decide whether they would like to join the social trip planning session. Additionally the invite may include a comment or message by the user and/or an automatically generated invite message.

In block 303, the system sends the invite to the one or more contacts (e.g., as an email message and/or messages or post sent to the social networking user accounts of the contacts). In one example, the system may issue a request to the social networking service hosting the user account for the contacts or the social group and may request that the social shopping network post the invite within the user account of each contact (e.g., using an API call). In one example, the post may be posted to the user account of the user at the social networking service and viewable by all contacts associated with the user at a social networking service. The contacts may select the link to join the social trip planning session.

In block 304, the system receives an indication of a contact requesting to join the social trip planning session. The contact may select the link or otherwise request to join the social trip planning session. Once an indication of a contact joining the social trip planning session is received by the social travel planning application, in block 305, the system adds the contact as a participant to the social trip planning session. For example, the system may associate the contact with the social trip planning session and provide a data set including information regarding the social trip planning session for display to the contact at the contact's client device.

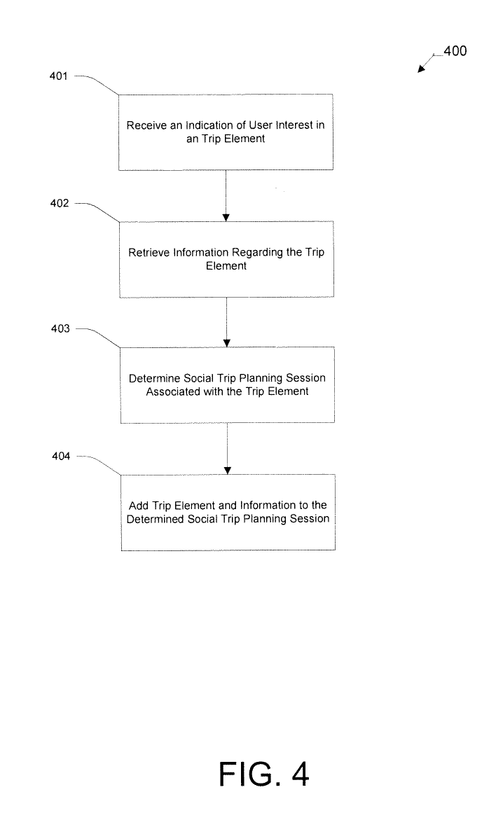

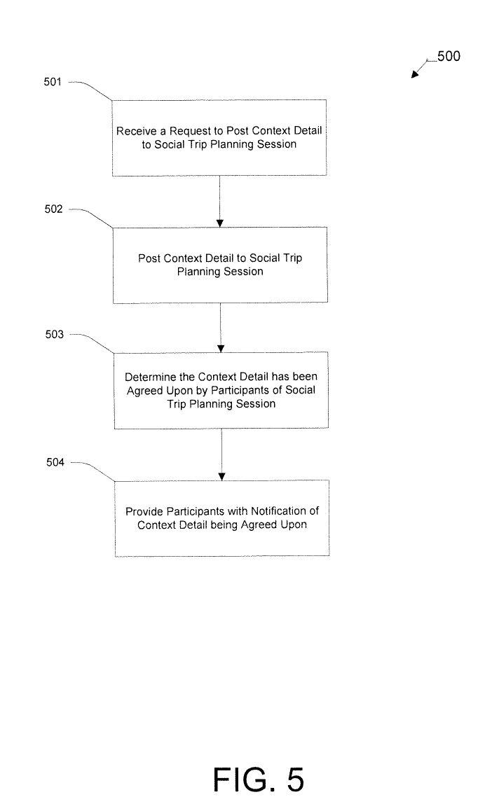

Once the social trip planning session participants (e.g., the user initiating the social trip planning session or contacts joining the social trip planning session) have joined the social trip planning session, the participants may individually browse various online retailer websites (e.g., similar to a solitary online shopping experience), or offline stores, for trip elements that the participants may be interested in purchasing and/or recommending to other participants and the trip elements may be added to the social trip planning session. An example process for adding a trip element to a social trip planning session is described in further detail below with respect to FIG. 4. Additionally, the session participants may post and/or collaborate on various context details regarding the trip. An example process for collaborating on context details of a trip is described in further detail below with respect to FIG. 5.

FIG. 4 illustrates a flow chart of an example process 400 for adding a trip element to a social trip planning session. In block 401, the system receives an indication of user interest in a trip element. The participants of the social trip planning session may browse online retail sites and physical (offline) stores and may add one or more trip elements to a social trip planning session. For example, when browsing one or more online retailer stores, the user may click a button to add the trip element currently being viewed to the social trip planning session. Similarly, a participant at an offline store may enter a trip element identifier, scan a barcode and/or enter information regarding the trip element (e.g., trip element characteristics and description) and may select to share the trip element with other participants of the social trip planning session. The system may also automatically detect user interest in a trip element (e.g., when the user views a trip element for a specific period of time) while the user is logged into the social travel planning application.

In one example, the social system may receive an indication of the location of the user (e.g., online or at an offline store) and may provide the user with the appropriate user interface for adding the trip element. For example, where the detected location of the user is an offline store, the user may be provided with prompts to scan a barcode, enter a trip element identifier or manually enter information regarding a trip element. On the other hand, if the user is online, the system may provide a button to the user for importing the trip element into the social travel planning application.

In block 402, the system retrieves information regarding the trip element. The social travel planning application may be implemented as a browser extension. For example, the online location of the user (e.g., a third party retailer website), and the trip element being viewed by the user at the online location may be detected using the URL. Upon detecting an indication of interest in the trip element, the browser may detect the URL and notify the browser extension. The browser extension may send the URL to a trip element search service (e.g., hosted at a remote server 120). The trip element search service may search across one or more databases for information regarding the trip element, and generate a trip element snippet. The snippet may include trip element information such as trip element name, identifier, time/date, price, description, provider, duration, special notes or requests (e.g., meal type, room type) and other similar trip element information. The snippet may be sent back to the browser extension, for displaying the trip element as part of the social travel planning application user interface.

Alternatively, some third party retailers may have an embedded button at their website which allows the user to add trip elements to the social travel planning application by selecting the embedded button. Once a trip element is detected, the third party retailer site may retrieve trip element information regarding the trip element (e.g., from the specific online site that the user is shopping from), and generate a snippet and provide the snippet to the system for display within the social travel planning application. The snippet may include trip element information such as trip element name, identifier, time/date, price, description, provider, duration, special notes or requests (e.g., meal type, room type) and other similar trip element information.

Similarly, trip elements from an offline store may be selected and shared with the participants of the social trip planning session at the social travel planning application. A user at an offline store may enter an identifier, name and/or information regarding a trip element and request to post the trip element to social trip planning session. The system may retrieve additional trip element information regarding the trip element (e.g., through the trip element search service using the barcode). For example, upon detecting the trip element identifier (e.g., barcode), the system may send the identifier to a trip element search service (e.g., hosted at a remote server 120). The trip element search service may search across one or more databases for information regarding the trip element, and generate a trip element snippet. The snippet may include trip element information such as trip element name, identifier, time/date, price, description, provider, duration, special notes or requests (e.g., meal type, room type) and other similar trip element information.

The user may also enter a comment or explanation regarding the trip element (e.g., asking for feedback, recommending the trip element to another participant of the social trip planning session, providing a specific fact about the trip element). Such information is received by the system and included within the trip element information associated with the trip element. Additionally, the system may detect the location of the participant indicating retailer information (e.g., based on the URL, through GPS, through the website or according to user input) and provide the retailer information and include the retailer information with the trip element information.

In block 403, the system determines the social trip planning session associated with the trip element. As described above, each user may participate in several social trip planning sessions. Thus, when the system receives an indication of user's interest in a trip element, the system may identify the social trip planning session that the trip element should be posted to. The trip elements detected or posted to the social trip planning session may be limited to trip elements relating to the context information indicated by the user initiating the social trip planning session. For example, the identification may be made according to the context information associated with each social trip planning session. The context information may provide information regarding the objectives and preferences of one or participants of the social trip planning sessions including one or more keywords associated with the social trip planning session. Additionally, the system may prompt the user for the appropriate social trip planning session and the user may indicate the appropriate social trip planning session for the trip element.

In block 404, the trip element along with the information retrieved in block 402, may be posted to the identified social trip planning session within the user's social travel planning application. In one example, the system provides various mechanisms within the display area displaying the social trip planning session for receiving feedback regarding the trip element from one or more participants of the social trip planning session. The mechanism may include an endorsement button, a mechanism for indicating a rating of the trip element, a comment box, a voting mechanism (e.g., yes/no button) or other similar means for inputting user opinions regarding the trip element.

The trip elements posted within the social trip planning session by each participant can be viewed by other participants of the social trip planning session and those participants may provide comments and feedback regarding the trip element using the provided feedback mechanisms. Participants can vote and comment on trip elements posted by other participants. The social trip planning session user interface may provide mechanisms (e.g., an endorsement button, a rating box, a comment box) for receiving feedback regarding the posted trip elements from the participants of the social shopping experience. The participants can for example endorse a trip element posted by other participants, rate the trip elements, vote “yes” or “no” on the trip element or recommend other trip elements in lieu of the posted trip elements to participants. Trip elements posted by each participant may be trip elements intended for the participant or trip element recommendations for other participants within the social trip planning session (e.g., recommendations for participants in the actual trip). The system may receive the feedback from each of the one or more participants and updated the social trip planning session to display the feedback associated with each trip elements to the one or more participants. Thus, the participants are able to view the trip elements posted to the social trip planning session and all feedback provided by the participants and associated with the posted trip elements.

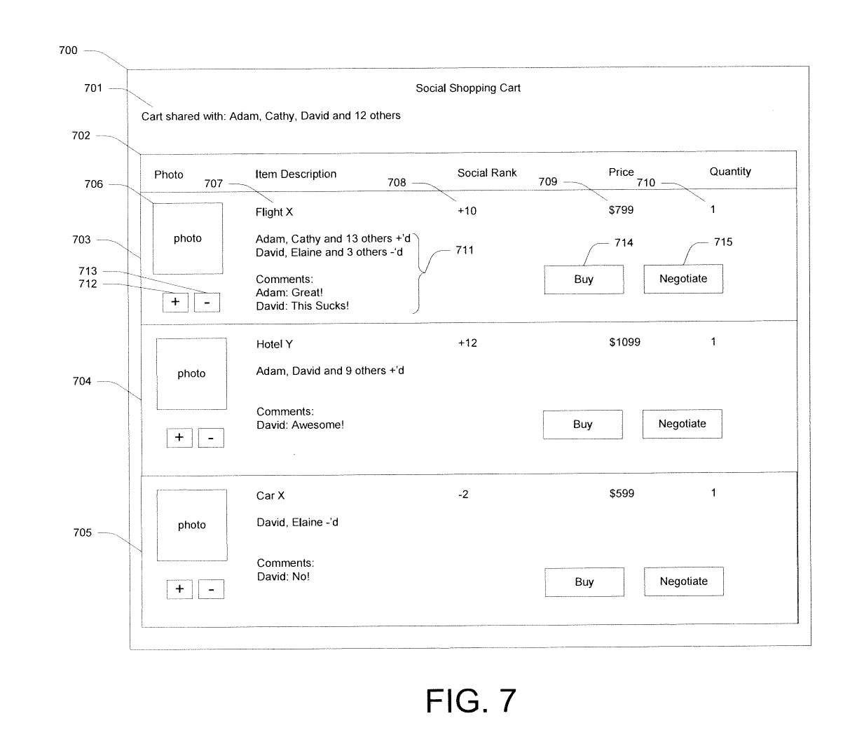

Based on the comments, feedback or votes by various participants of the social trip planning session the trip element may be selected a placed within a social shopping cart associated with the social trip planning session and/or participants of the social trip planning session. For example, a participant may select a trip element from the social trip planning session and add the trip element to a social shopping cart for purchase. An example graphical user interface displaying a social shopping cart is discussed in further detail below with respect to FIG. 7. In one example, the user interface may include an “add to cart” mechanism and once the participants have decided that they would like to purchase the trip element, the trip element may be added to the cart for the participant. Furthermore, the social trip planning session may include a group cart, where the participants may add trip elements intended for the entire group.

The social trip planning session may be shared with other users not necessarily participating in the social trip planning session. In one example, a summary of the social trip planning session may be generated and made available for viewing by other users. The summary may include a listing of trip elements that were viewed during the social trip planning session and may further include information regarding how those trip elements were rated by the participants of the social trip planning session. The summary may also include further details regarding the social trip planning session such as comments, or other feedback made regarding the trip elements by the participants of the social trip planning session. Context information and details, and feedback regarding the context details may further be included within the summary.

Similarly, a user may also add one or more context details to the social trip planning session, for the purpose of collaboration and agreement. FIG. 5 illustrates a flow chart of an example process for collaborating on context details regarding a trip. In step 501, the system receives a user request to post a context detail to a social trip planning session. The context detail may include various trip objectives and/or preferences such as a date range, flight time, types of activities, destination, preferred carrier or provider of transportation or accommodations, suggested trip companions and various other trip details.

In step 502, the system posts the suggested trip detail(s) to the social trip planning session and provides one or more mechanisms for receiving feedback regarding the trip detail. In one example, the feedback mechanisms may include a vote button for receiving approval or disapproval from participants of the social trip planning session. A comment box for receiving free form text comments from the participants and other similar feedback mechanisms. In one example, when posting the context detail, the system may have access to information regarding the participants such as preferred destinations, availability, and other similar information according to past or concurrent activities of the participants and may provide a notification to the user or all participants regarding the likelihood of the context detail being favorable to the all participants who are going to participate in the actual trip.

In step 503, the system determines that the context detail is an agreed upon context detail for the trip based on feedback from participants of the social trip planning session. In one example, the context detail determination occurs when the system receives an input from a participant of the social trip planning session, indicating that the context detail is agreeable and that the trip will be planned according to the agreed upon context detail. Alternatively, the system may receive feedback from the participants of the social trip planning session and based on the feedback, the system may determine that the context detail has been agreed upon. For example, a threshold condition such a positive vote from all or a majority of participants or those participants joining the actual trip may be set, and when the condition is met the system determines that the context detail is agreed upon for the trip.

In step 504, the system provides a notification to the participants informing them of the agreed upon context information. The system may add the context detail to the context information associated with the trip (e.g., upon receiving approval from participant(s) of the social trip planning session). In one example, the system may further filter the trip elements displayed within the social trip planning session, and/or the recommendations, advertisements and/or search results provided to the participants according to the agreed upon context detail. Additionally, the system may make recommendations based on the agreed upon context details (e.g., recommendations for flights for an agreed upon time range, to and from the destination, or for a specific price range).

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

IV. Example Graphical User Interfaces of a Social Trip Planning Session

FIG. 6 illustrates an example screen shot of a graphical user interface displaying a web browser 600 including a social travel planning application. In the illustrated example, the social travel planning application is illustrated as a browser extension displayed on the browser window along with an online retail site being visited by a user. The web browser 600 includes a task bar area including an address bar and one or more navigation buttons. The browser window further includes a web site display area 601 and a travel planning application display area 605. An online retail site being visited by a user is illustrated within the website display area 601. In the example online retail site displays two flights 602 and 603 available for sale are illustrated. The online retailer site displays a first trip element 602, “flight Z” including an image and information regarding the trip. An embedded “add to your shopping trip” button 604 is included within the online retailer site for facilitating the adding of the trip element 602 from the site to the trip planning session of the user. The online retailer site further displays social information regarding the item (e.g., whether contacts of the user have added the trip element to their social trip planning session). A second trip element, “flight X” is also displayed along with item information and a photo. “flight X” is illustrated as being added to the social shopping trip of the user.

The social shopping application area 605 displays three separate social trip planning sessions within tabs 606, 607 and 608. Tab 606 includes trip elements added to a social trip planning session labeled “Mexico trip”, tab 607 includes items added to a trip planning session labeled “California trip” and tab 608 includes items added to a social shopping trip labeled “New York trip”. Tab 606 corresponding to the Mexico rip is displayed as being selected by the user and displays two trip elements 609 and 614 having been added to the trip planning session. Each trip element is displayed within a distinct area. Information displayed for each trip element is generally described with respect to trip element 609. The first trip element 609 is a flight Y added by a first user Astrid. The information regarding the flight as well as a photo is displayed within a trip element information area 613. The tab 606 further displays comments and further social endorsement data regarding the trip element 609 in a social information area 611. In addition feedback mechanisms 610 are displayed within the display area for facilitating the input of a comment regarding trip element 609, as well as endorsing or disliking the trip element. An “add to cart” button 612 is further displayed in association with the trip element 609 for allowing the user to add the trip element to a social shopping cart. Similar information is provided for a second trip element 614, the information including social information, information and photo regarding the trip element, social input mechanisms and an add to cart button.

At the button of the social travel planning application area 605 various input mechanisms are provided to allow the user to interact with the application. A “create new trip” button 615 facilitates the creation of a new trip planning session. An “invite friends” button 616 allows the user to add more friends to one or more of his/her trip planning sessions, the “share an item” button 617 allows the user to share one of his/her trip elements with one or more contacts in one or more trip planning sessions. The “view cart” button 618 facilitates the navigation to the user's one or more social shopping carts, and a “view trip info” button 619 allows the user to view information regarding one or more of his/her social trip planning sessions. A secondary information area 620 is further displayed within the social shopping application display area 605 displaying one or more item advertisements and/or recommendations. The advertisements and/or recommendations may additionally include social information showing whether the advertised and/or recommended trip element(s) are endorsed and/or purchased by other users (e.g., contacts of the user associated with the social shopping application).

FIG. 7 illustrates a screen shot of a graphical user interface displaying an example social shopping cart 700. The social shopping cart 700 includes a general display area 701, and an item display area 702. The general display area 701 provides general social information regarding the social shopping cart, including for example, whether the social shopping cart is being shared and/or viewed by contacts of the user. The item display area displays trip elements 703, 704 and 705. Information displayed for each item is generally described with respect to trip element 703. Trip element 703 is displayed within the cart including a photo 706, a description 707, a social rank 708, a price 709, a quantity 710, social information area 711, endorsement mechanisms 712 and 713 and purchase mechanisms 714 and 715. The social rank 708 may provide information regarding the popularity of the trip element among contacts of the user (e.g., participants within the social shopping trip that the item is posted). For example, trip element 703 is indicated as having a social ranking of +10, indicating that of the people who provided feedback, 10 more people endorsed rather than provide negative feedback regarding the item.

Further detail regarding the feedback of contacts regarding the trip element is provided in the social information area 711. The social information area 711 provides information regarding how many contacts provided positive endorsements rather than negative input regarding the trip element, and may further provide the identity of those users. Additionally, the social information area displays comments regarding the trip element provided by contacts. The feedback displayed as the social information area 711 may comprise feedback provided by participants of the a social trip planning sessions where the trip element is posted and is displayed within the cart and updated as the feedback information is provided at the social trip planning session. The endorsement mechanisms 712 and 713 allow the user to provide feedback regarding the trip element. A “buy” button 714 is provided and allows the user to request to purchase the trip element. Additionally, as illustrated, a “negotiate” button 715 may be provided to allow the user to request that the listed price 709 of the trip element be negotiated by the system.

The social rank assigned to each item within the social shopping cart is calculated here as the difference between the positive endorsements (+s) and the negative feedback (−s) of the users with regard to the item, however, other feedback data such as votes, ratings, and comments may also be considered when calculating the social rank for each item. The items within the social shopping cart may be ranked according to the social ranking. This makes the decision making process more efficient where the user is able to make purchasing decisions based on how his/her contacts have responded to the item (e.g., based on the positive/negative feedback or endorsement of the item).

V. Example System for Facilitating a Social Travel Planning Experience

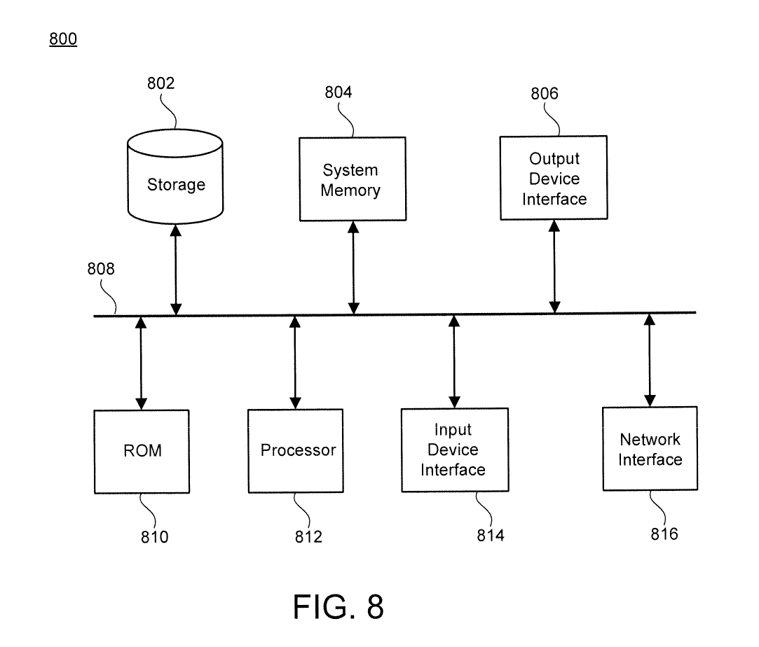

FIG. 8 conceptually illustrates an electronic system with which some implementations of the subject technology are implemented. Electronic system 800 can be a server, computer, phone, PDA, laptop, tablet computer, television with one or more processors embedded therein or coupled thereto, or any other sort of electronic device. Such an electronic system includes various types of computer readable media and interfaces for various other types of computer readable media. Electronic system 800 includes a bus 808, processing unit(s) 812, a system memory 804, a read-only memory (ROM) 810, a permanent storage device 802, an input device interface 814, an output device interface 806, and a network interface 816.

Bus 808 collectively represents all system, peripheral, and chipset buses that communicatively connect the numerous internal devices of electronic system 800. For instance, bus 808 communicatively connects processing unit(s) 812 with ROM 810, system memory 804, and permanent storage device 802.

From these various memory units, processing unit(s) 812 retrieves instructions to execute and data to process in order to execute the processes of the subject disclosure. The processing unit(s) can be a single processor or a multi-core processor in different implementations.

ROM 810 stores static data and instructions that are needed by processing unit(s) 812 and other modules of the electronic system. Permanent storage device 802, on the other hand, is a read-and-write memory device. This device is a non-volatile memory unit that stores instructions and data even when electronic system 800 is off. Some implementations of the subject disclosure use a mass-storage device (such as a magnetic or optical disk and its corresponding disk drive) as permanent storage device 802.

Other implementations use a removable storage device (such as a floppy disk, flash drive, and its corresponding disk drive) as permanent storage device 802. Like permanent storage device 802, system memory 804 is a read-and-write memory device. However, unlike storage device 802, system memory 804 is a volatile read-and-write memory, such a random access memory. System memory 804 stores some of the instructions and data that the processor needs at runtime. In some implementations, the processes of the subject disclosure are stored in system memory 804, permanent storage device 802, and/or ROM 810. For example, the various memory units include instructions for facilitating a social travel planning experience. From these various memory units, processing unit(s) 812 retrieves instructions to execute and data to process in order to execute the processes of some implementations.

Bus 808 also connects to input and output device interfaces 814 and 806. Input device interface 814 enables the user to communicate information and select commands to the electronic system. Input devices used with input device interface 814 include, for example, alphanumeric keyboards and pointing devices (also called “cursor control devices”). Output device interfaces 806 enables, for example, the display of images generated by the electronic system 800. Output devices used with output device interface 806 include, for example, printers and display devices, such as cathode ray tubes (CRT) or liquid crystal displays (LCD). Some implementations include devices such as a touchscreen that functions as both input and output devices.

Finally, as shown in FIG. 8, bus 808 also couples electronic system 800 to a network (not shown) through a network interface 816. In this manner, the computer can be a part of a network of computers (such as a local area network (“LAN”), a wide area network (“WAN”), or an Intranet, or a network of networks, such as the Internet. Any or all components of electronic system 800 can be used in conjunction with the subject disclosure.

These functions described above can be implemented in digital electronic circuitry, in computer software, firmware or hardware. The techniques can be implemented using one or more computer program trip elements. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that all illustrated steps may not be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software trip element or packaged into multiple software trip elements.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure. Features under one heading may be combined with features under one or more other headings and all features under a heading need not be used together.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method, executed on one or more computing devices, for facilitating a social travel planning environment, the method comprising:
receiving an indication of interest in an trip element being viewed at a remote store by a user participating in a social trip planning session, wherein the remote store is one of an online store or an offline store, wherein the social trip planning session includes one or more participants interested in planning a trip;
retrieving, using the one or more computing devices, information regarding the trip element in response to receiving the indication, the information including trip element information corresponding to the trip element; and
providing the trip element and the retrieved information to be displayed to the one or more participants of the social trip planning session and providing a mechanism for receiving feedback regarding the trip element from the one or more participants.

2. The method of claim 1, wherein the social trip planning session is associated with the a user account of the user at a social travel planning application, the social travel planning application maintaining one or more social trip planning sessions associated with the user, the social travel planning application including a display area corresponding to the social trip planning session for displaying one or more trip elements posted to the social trip planning session by the one or more participants of the social trip planning session.

3. The method of claim 1, further comprising:
determining, using the one or more computing devices, the social trip planning session associated with the trip element, wherein the user associated is associated with one or more social trip planning sessions including the social trip planning session.

4. The method of claim 1, further comprising:
receiving a request to add a context detail to the social trip planning session, the context detail including one of a date, date range, time, transportation type, activity type, preferred provider, one or more trip companions, or price range; and
providing the context detail for display to the participants of the social trip planning session, and providing a mechanism for receiving feedback regarding the context detail from the one or more participants.

5. The method of claim 4, further comprising:
receiving an indication of feedback regarding the context detail from one or more of the one or more participants of the social trip planning session;
determining that the context detail has been approved based on the feedback; and
adding the context detail to context information associated with the trip.

6. The method of claim 1, further comprising:
determining one or more recommended context details based upon one or more of information provided by the one or more participants, the activities of the one or more participants with respect to one or more other social trip planning sessions, activity and context information associated one or more other social trip planning sessions similar to the social trip planning session or one or more other users similar to at least one of the one or more participants; and
providing the one or more recommended context details for display to the one or more participants, the recommended context details comprising at least one of date, date range, time, transportation type, activity type, preferred provider, one or more trip companions, or price range for the trip.

7. The method of claim 1, further comprising:
receiving a request to add one or more contacts to the social trip planning session, the contacts being associated with the user, the request providing an indication of contact information for the one or more contacts;
generating an invite to the social trip planning session in response to the request; and
sending the invite to the one or more contacts according to the contact information.

8. The method of claim 7, further comprising:
receiving an indication of at least one of the one or more contacts joining the social trip planning session in response to sending the invite; and
adding the at least one of the one or more contacts as a participant of the social trip planning session.

9. The method of claim 8, wherein the invite includes a link to the social trip planning session and wherein the indication is received in response to the at least one of the one or more contacts selecting the link.

10. The method of claim 1, wherein the trip element is displayed to each of the one or more participants at a device associated with each of the one or more participants, wherein the one or more participants are physically remote from one another.

11. The method of claim 1, wherein at least one of the one or more participants is associated with one or more social trip planning sessions including the social trip planning session, and
wherein the one or more social trip planning sessions including the social trip planning session are displayed within a display area of a social travel planning application associated with a user account of the user at the user's device.

12. The method of claim 1, further comprising:
receiving feedback from one of the one or more participants regarding the trip element; and
updating the social trip planning session to display the feedback regarding the trip element.

13. The method of claim 1, wherein the feedback comprises one or more of a vote on the trip element, a rating of the trip element, an endorsement of the trip element, a recommendation of an alternative trip element in lieu of the trip element or a comment regarding the trip element.

14. The method of claim 1, wherein retrieving information regarding the trip element comprises:
sending a request to a trip element search service to retrieve information regarding the trip element, the trip element search service maintaining information regarding the trip element; and
receiving an information snippet, the information snippet including one or more of trip element information and retailer information.

15. The method of claim 1, wherein the remote store comprises an online retail site and wherein retrieving information regarding the trip element comprises receiving information regarding the trip element from the online retail site.

16. The method of claim 1, further comprising:
determining one or more trip element characteristics associated with the social trip planning session, based on one or more of context information associated with the social trip planning session, trip elements posted to the social trip planning session by the one or more participants or feedback data regarding the posted trip elements provided by the one or more participants; and
determining, one or more user preferences preferred by the one or more participants, wherein the user preferences are determined based on activities of the one or more participants with regard to one or more social trip planning sessions that the participant has participated in.

17. The method of claim 16, further comprising:
providing at least one advertisement for display to the one or more participants based on the determined one or more trip element characteristics and the one or more user preferences.

18. The method of claim 16, further comprising:
providing at least one recommended trip element for display to the one or more participants based on the determined one or more trip element characteristics and the one or more user preferences.

19. The method of claim 1, wherein the social trip session is associated with context information, the context information includes one or more of trip element characteristics desirable by the one or more participants, and context details regarding the details of the trip, the context detail including one or more of date, date range, time, transportation type, activity type, preferred provider, one or more trip companions, or price range.

20. A system for facilitating a social trip planning session environment, the system comprising:
one or more processors; and
a machine-readable medium comprising instructions stored therein, which when executed by the processors, cause the processors to perform operations comprising:
receiving an indication of interest in an trip element being viewed at a remote store by a user participating in one or more social trip planning sessions, wherein the remote store is one of an online store or a offline store, wherein each of the one or more social trip planning sessions includes one or more participants associated with the social trip planning session, and wherein each of the one or more social trip planning session is associated with context information;
retrieving information regarding the trip element in response to receiving the indication, the information including at least one of trip element information corresponding to the trip element or retailer information corresponding to the store;
identifying one of the one or more social trip planning sessions based on the context information associated with each of the one or more social trip planning sessions; and
adding the trip element and the retrieved information to the identified social trip planning session, and providing a mechanism for receiving feedback regarding the trip element from the one or more participants.

21. The system of claim 20, the operations further comprising:
receiving a request to add a context detail to the social trip planning session, the context detail including one of a date, date range, time, transportation type, activity type, preferred provider, one or more trip companions, or price range; and
providing the context detail for display to the participants of the social trip planning session, and providing a mechanism for receiving feedback regarding the context detail from the one or more participants.

22. The system of claim 21, the operations further comprising:
receiving an indication of feedback regarding the context detail from one or more of the one or more participants of the social trip planning session;
determining that the context detail has been approved based on the feedback; and
adding the context detail to the context information associated with the social trip planning session.

23. The system of claim 20, wherein the context information includes one or more of trip element characteristics desirable by the one or more participants, and context details regarding the details of the trip, the context detail including one or more of date, date range, time, transportation type, activity type, preferred provider, one or more trip companions, or price range.

24. A machine-readable medium comprising instructions stored therein, which when executed by a machine, cause the machine to perform operations comprising:
receiving an indication of interest in an trip element being viewed at a remote store by a user participating in a social trip planning session, wherein the social trip planning session includes one or more participants, and wherein the social trip planning session is associated with context information including one or more of trip element characteristics desirable by the one or more participants, and context details regarding the details of the trip, the context detail including one or more of date, date range, time, transportation type, activity type, preferred provider, one or more trip companions, or price range;
retrieving information regarding the trip element in response to receiving the indication, the information including trip element information corresponding to the trip element; and
adding the trip element and the retrieved information to the social trip planning session, such that the trip element is displayed to each of the one or more participants, and providing a mechanism for receiving feedback regarding the trip element from the one or more participants.

25. The machine-readable medium of claim 23, the operations further comprising:
receiving a request to create the social trip planning session from the user;
receiving context information regarding the social trip planning session;
creating the social trip planning session; and
providing the social trip planning session for display within the social travel planning application associated with the user account of the user.

26. The machine-readable medium of claim 23, the operations further comprising:
receiving a request to add one or more contacts to the social trip planning session, the contacts being associated with the user, the request providing an indication of contact information for the one or more contacts;
generating an invite to the social trip planning session in response to the request; and
sending the invite to the one or more contacts according to the contact information for each of the one or more contacts;
receiving an indication of at least one of the one or more contacts joining the social trip planning session in response to sending the invite; and
adding the at least one of the one or more contacts as a participant of the social trip planning session.
